(19) United States
(12) Patent Application Publication
(10) Pub. No.: US 2022/0281390 A1
(43) Pub. Date: Sep. 8, 2022

(54) LADDER MOUNTED RACKS

(71) Applicant: Joseph Oshman, Portland, OR (US)

(72) Inventor: Joseph Oshman, Portland, OR (US)

(21) Appl. No.: 17/825,915

(22) Filed: May 26, 2022

(51) Int. Cl. B60R 9/06

(52) U.S. Cl. CPC B60R 9/06

(57) ABSTRACT

Racks supporting an item and mounting to a ladder having a vertical member. The racks include a rail, a clamp, and a hook. The rail abuts a first side of the vertical member of the ladder. The clamp secures the rail to the vertical member of the ladder. The clamp includes a plate and a coupler. The plate is disposed on a second side of the vertical member, the second side is opposite the first side. The coupler is configured to compress the vertical member between the plate and the rail. The coupler couples the plate and the rail. The hook is operatively mounted to the rail and configured to support the item.

### BACKGROUND

The present disclosure relates generally to racks. In particular, racks configured to mount to ladders are described.

Racks are popular and convenient for mounting items, such as bicycles, skis, luggage, tools, and the like. Racks can be mounted to vehicles to facilitate transporting items to different locations. Racks mount to vehicles in different locations, such as on top of or behind the vehicle. This document will focus on racks that mount behind vehicles, but the racks could mount to ladders located anywhere on a vehicle or ladders located elsewhere not mounted to a vehicle.

Known racks designed to mount behind vehicles are not entirely satisfactory. For example, existing racks are configured to mount to the hitch of a vehicle, which requires a vehicle to have a hitch or a hitch receiver. It is not always feasible or convenient to have a hitch or hitch receiver on a vehicle.

Conventional racks mounted to a hitch tend to greatly restrict access to rear doors of a vehicle. Further, conventional racks mounted on a hitch limit the angle at which a vehicle may move because they extend out from the rear of a vehicle low to the ground. The low, extended position of conventional racks mounted to hitches makes them prone to contacting the ground as the vehicle moves. Contacting the ground can damage the racks, damage the items supported on the racks, and/or prevent the vehicle from moving.

Conventional racks that mount to the rear of the vehicle by means other than a hitch also suffer drawbacks. For example, conventional racks can be difficult for one person to load items on them. Further, conventional racks are often undesirably high off the ground, which makes them difficult to use.

It would be desirable to have an improved rack that mounted to a ladder, such as a ladder mounted to the rear of a vehicle. Ideally, an improved rack would not block the rear doors on a vehicle, such as a van, from operating. It would be beneficial if an improved rack enabled items to be supported in a dense configuration.

A novel rack would provide convenience if it included features allowing it to be mounted to a variety of ladder widths. Preferably, the novel rack would have minimal impact on the usability of the ladder to which it mounted.

Thus, there exists a need for racks that improve upon and advance the design of known racks. Examples of new and useful racks relevant to the needs existing in the field are discussed below.

Examples of references relevant to racks discussed herein include U.S. patent Ser. No. 11/142,133 and U.S. patent application Ser. Nos. 17/214,670, 17/412,782, 17/514,247, 17/714,487. The complete disclosures of the above patents and patent applications are herein incorporated by reference for all purposes.

### SUMMARY

The present disclosure is directed to racks supporting an item and mounting to a ladder having a vertical member. The racks include a rail, a clamp, and a hook. The rail abuts a first side of the vertical member of the ladder. The clamp secures the rail to the vertical member of the ladder. The clamp includes a plate and a coupler. The plate is disposed on a second side of the vertical member. The second side is opposite the first side. The coupler is configured to compress the vertical member between the plate and the rail. The coupler couples the plate and the rail. The hook is operatively mounted to the rail and configured to support the item.

In some examples, the plate defines a plate slot extending through the plate, the rail defines a mounting slot extending through the rail, the rail defines a front face facing away from the vertical member, and the coupler extends through the mounting slot to extend past the front face. In certain examples, the coupler includes a bolt and a nut. The bolt extends through the plate slot and through the mounting slot to extend past the front face. The nut threadingly mounts to the bolt proximate the front face and is configured to press the front face of the rail towards the plate to compress the vertical member between the plate and the rail. In certain examples, the mounting slot extends longitudinally to enable the coupler to extend through the mounting slot in a selected longitudinal position along the rail.

This document describes certain examples where the hook mounts to the coupler proximate the front face of the rail. In select embodiments, the hook further mounts to the rail.

As described below, in particular instances the rail extends horizontally, and the hook is oriented at an angle relative to the rail to support the object in a horizontally tilted orientation. In certain examples, the hook includes a hook member and a retention member. The hook member is configured to support the item. The retention member is disposed proximate to the hook member and operable to selectively secure the item supported on the hook member. In some examples, the rack includes an arm abutting a first side of the vertical member of the ladder and vertically spaced from the rail. The rack may include a second clamp securing the arm to the vertical member of the ladder.

In some examples, the second clamp includes a second plate disposed on the second side of the vertical member and a second coupler coupling the second plate and the arm rail.

This document describes certain examples where the coupler is configured to compress the vertical member between the second plate and the arm.

In select embodiments, the second plate defines a second plate slot extending through the second plate, the arm defines an arm mounting slot extending through the arm, the arm defines an arm front face facing away from the vertical member, and the second coupler extends through the arm mounting slot to extend past the arm front face. In certain examples, the second coupler includes a second bolt extending through the second plate slot and through the arm mounting slot to extend past the arm front face. The second coupler may include a second nut threadingly mounted to the second bolt proximate the arm front face and configured to press the arm front face towards the second plate to compress the vertical member between the second plate and the arm.

As described below, in particular instances the arm mounting slot extends longitudinally to enable the second coupler to extend through the arm mounting slot in a selected longitudinal position along the arm.

In some examples, the arm includes a support plate extending away from the vertical member.

This document describes certain examples where the support plate is operable to restrict the item from contacting the vertical member proximate the arm when the item is supported by the hook.

In select embodiments, the support plate defines a recess to receive a portion of the item and to restrict the item from moving by abutting the portion of the item within the recess on multiple sides.

As described below, in particular instances the arm includes a second retention strap proximate the recess. The second retention strap may be operable to selectively restrict the portion of the item within the recess from exiting the recess.

The arm may include an interface plate extending transverse to the support plate and abutting the vertical member. In some examples, the interface plate is integrally coupled to the support plate.

### BRIEF DESCRIPTION OF THE DRAWINGS

FIG. 1 is a perspective view of a first embodiment of a rack for supporting bicycles mounted to a ladder of a vehicle.

FIG. 2 is a front elevation view of the rack shown in FIG. 1.

FIG. 3 is a side elevation view of the rack shown in FIG. 1.

FIG. 4 is a top plan view of the rack shown in FIG. 1.

FIG. 5 is a perspective view of the rack shown in FIG. 1 without bicycles supported on the rack.

FIG. 6 is a close up perspective view of a rail, a clamp, and a hook of the rack shown in FIG. 1.

FIG. 7 is a close up perspective view of an arm and a second clamp of the rack shown in FIG. 1.

### DETAILED DESCRIPTION

The disclosed racks will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various racks are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Ladder Mounted Racks

With reference to the figures, ladder mounted racks will now be described. The racks discussed herein function to support items. Further, the racks described below mount to a vehicle, in particular, the racks mount to a ladder secured to a vehicle.

The reader will appreciate from the figures and description below that the presently disclosed racks address many of the shortcomings of conventional racks. For example, the novel racks discussed herein mount to a ladder rather than to a hitch or hitch receiver of a vehicle. As a result, the novel racks do not require a vehicle to have a hitch or hitch receiver.

The novel racks discussed in this document do not block operation of the rear doors on a vehicle, such as a van. Beneficially, the novel racks described below enable items, such as bicycles, to be supported in a dense configuration.

Conveniently, the novel racks discussed herein include features allowing them to be mounted to a variety of ladder widths. Further, the novel racks have minimal impact on the usability of the ladder to which they are mounted.

Contextual Details

Ancillary features relevant to the racks described herein will first be described to provide context and to aid the discussion of the racks.

Items

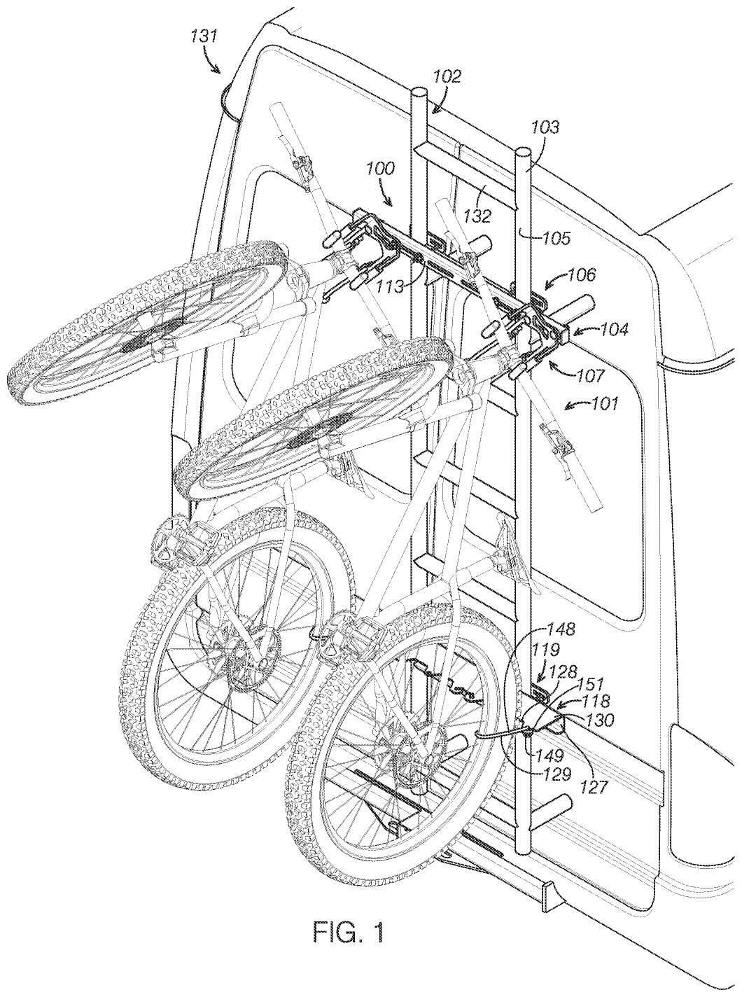

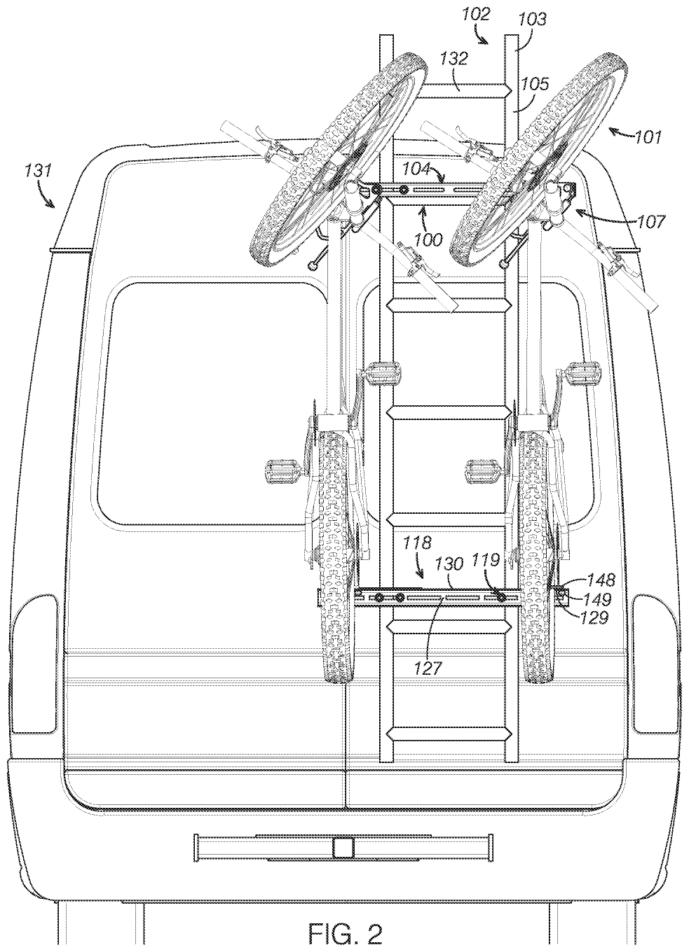

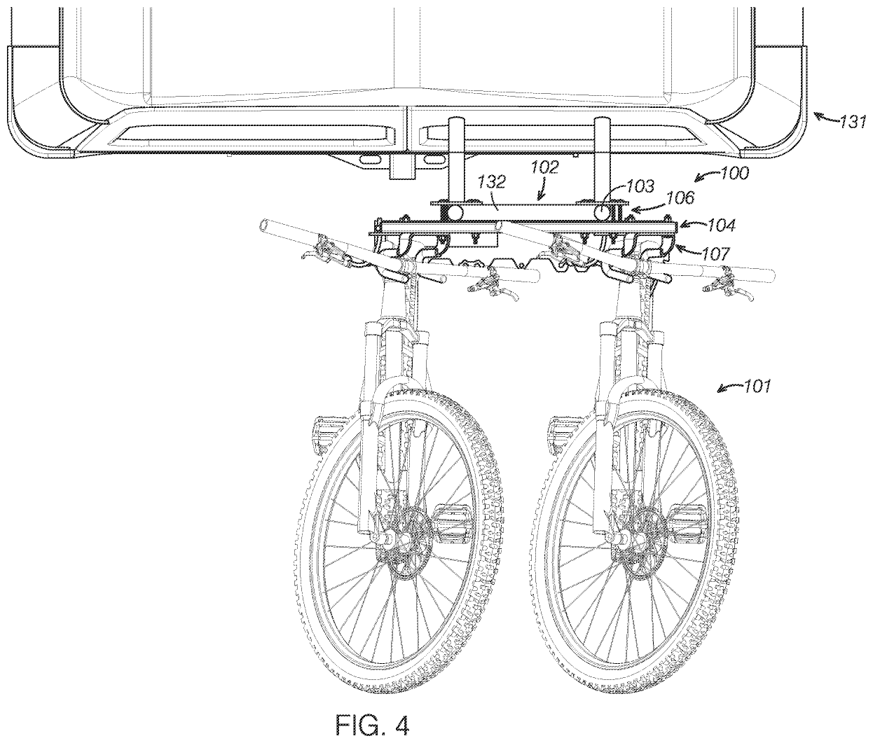

The racks discussed herein function to support items. In the present example, as shown in FIGS. 1-4, items 101 are bicycles.

However, the items may be any currently known or later developed type of item suitable for mounting to a rack, such as bicycles, skis, luggage, tools, and equipment. Various item types exist and could be used in place of the items shown in the figures. In addition to the types of items existing currently, it is contemplated that the racks described herein could be used with new types of items developed in the future.

The number of items in the rack may be selected to meet the needs of a given application. The reader should appreciate that the number of items may be different in other examples than is shown in the figures. For instance, some rack examples are used with additional or fewer items than described in the present example.

The size and shape of the item may be varied as needed for a given application. In some examples, the item is larger relative to the other components than depicted in the figures. In other examples, the item is smaller relative to the other components than depicted in the figures. Further, the item and the other components may all be larger or smaller than described herein while maintaining their relative proportions.

Ladder

The racks described in this document are configured to selectively mount to a ladder 102. The ladder may be freestanding, mounted to a wall, or, as shown in FIGS. 1-4, mounted to a vehicle 131.

In the present example, ladder 102 includes two vertical members 103 and a plurality of steps 132. Vertical members 103 mount to vehicle 131 and are horizontally spaced. Vertical members 103 support plurality of steps 132 spanning between them. Steps 132 are vertically spaced from each other along vertical members 103.

The size and shape of the ladder may be varied as needed for a given application. In some examples, the ladder is larger relative to the other components than depicted in the figures. In other examples, the ladder is smaller relative to the other components than depicted in the figures. Further, the reader should understand that the ladder and the other components may all be larger or smaller than described herein while maintaining their relative proportions.

In the present example, ladder 102 is composed of metal. However, the ladder may be composed of any currently known or later developed material suitable for ladder applications. Suitable materials include metals, polymers, wood, and composite materials.

Rack Embodiment One

With reference to FIGS. 1-7, a rack 100 will now be described as a first example of a rack. As shown in FIGS. 1-4, rack 100 is for supporting items 101 and mounting to ladder 102. The reader can see in FIGS. 1-7 that rack 100 includes a rail 104, a clamp 106, an arm 118, a second clamp 119, and a hook 107. In other examples, the rack includes fewer components than depicted in the figures. In certain examples, the rack includes additional or alternative components than depicted in the figures.

The rack may be any currently known or later developed type of rack, including bike racks, luggage racks, equipment racks, tool racks, and the like. A variety of rack types exist and could be used in place of the rack shown in the figures. In addition to the types of racks existing currently, it is contemplated that the racks described herein could embody new types of racks developed in the future.

The size and shape of the rack may be varied as needed for a given application. In some examples, the rack is larger relative to the other components than depicted in the figures. In other examples, the rack is smaller relative to the other components than depicted in the figures. Further, the reader should understand that the rack and the other components may all be larger or smaller than described herein while maintaining their relative proportions.

Rail

The role of rail 104 is to support hook 107 and to couple with ladder 102 in cooperation with clamp 106. The reader can see in FIGS. 1, 2, 5, and 6 that rail 104 extends horizontally between vertical members 103 of ladder 102. As depicted in FIGS. 1-6, rail 104 abuts a first side 105 of vertical member 103 of ladder 102.

As shown in FIGS. 1-6, rail 104 defines a front face 113 facing away from vertical member 103. The reader can see in FIGS. 1-6 that hook 107 and other similarly configured hooks are supported on front face 113 of rail 104.

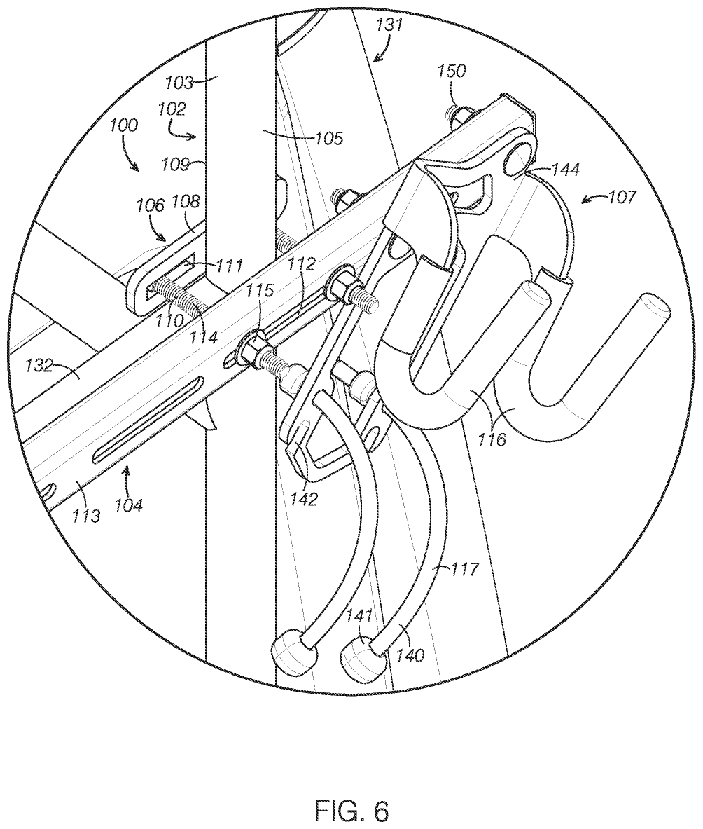

Rail 104 couples with clamp 106 to couple with ladder 102 via compressive engagement. With reference to FIG. 6, rail 104 defines a mounting slot 112 extending through rail 104. Coupler 110 of clamp 106 extends through mounting slot 112.

The number of rails in the rack may be selected to meet the needs of a given application. The reader should appreciate that the number of rails may be different in other examples than is shown in the figures. For instance, some rack examples include additional or fewer rails than described in the present example.

The size and shape of the rail may be varied as needed for a given application. In some examples, the rail is larger relative to the other components than depicted in the figures. In other examples, the rail is smaller relative to the other components than depicted in the figures. Further, the reader should understand that the rail and the other components may all be larger or smaller than described herein while maintaining their relative proportions.

In the present example, the rail is composed of metal. However, the rail may be composed of any currently known or later developed material suitable for structural applications. Suitable materials include metals, polymers, ceramics, wood, and composite materials.

Mounting Slot

Mounting slot 112 enables coupler 110 of clamp 106 to pass through rail 104. Coupler 110 passing through rail 104 facilitates clamp 106 exerting compressive force on opposite sides of vertical members 103 of ladder 102 to secure rail 104 to ladder 102.

As depicted in FIG. 6, mounting slot 112 extends longitudinally through rail 104. Mounting slot 112 extending longitudinally enables coupler 110 to extend through mounting slot 112 in a selected longitudinal position along rail 104.

The number of mounting slots in the rack may be selected to meet the needs of a given application. The reader should appreciate that the number of mounting slots may be different in other examples than is shown in the figures. For instance, some rack examples include additional or fewer mounting slots than described in the present example.

The size and shape of the mounting slot may be varied as needed for a given application. In some examples, the mounting slot is larger relative to the other components than depicted in the figures. In other examples, the mounting slot is smaller relative to the other components than depicted in the figures. Further, the reader should understand that the mounting slot and the other components may all be larger or smaller than described herein while maintaining their relative proportions.

Clamps

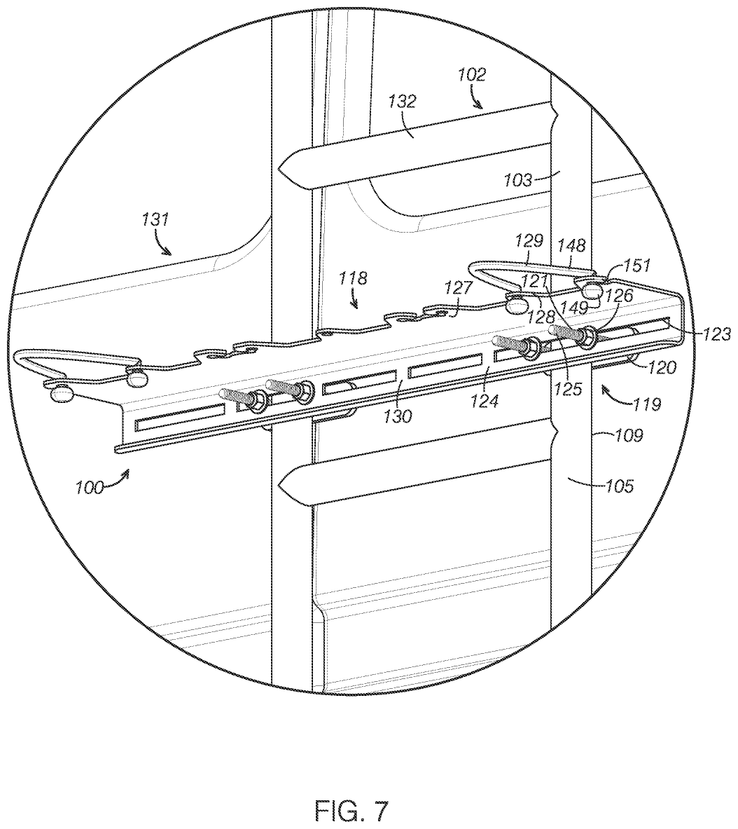

The role of the clamps is to secure rail 104 and arm 118 to ladder 102 via compressive engagement. With reference to FIGS. 1-6, clamp 106 secures rail 104 to vertical member 103 of ladder 102. The reader can see in FIG. 7 that second clamp 119 secures arm 118 to vertical member 103 of ladder 102.

As shown in FIGS. 1, 5, and 6, clamp 106 includes a plate 108 and a coupler 110. As depicted in FIG. 7, second clamp 119 includes a second plate 120 and a second coupler 121. The components of clamps 106 and 119 are explained in more details in the sections below.

The clamps may be any currently known or later developed type of clamp. Various clamp types exist and could be used in place of the clamps shown in the figures. In addition to the types of clamps existing currently, it is contemplated that the racks described herein could incorporate new types of clamps developed in the future.

The number of clamps in the rack may be selected to meet the needs of a given application. The reader should appreciate that the number of clamps may be different in other examples than is shown in the figures. For instance, some rack examples include additional or fewer clamps than described in the present example.

The size and shape of the clamps may be varied as needed for a given application. In some examples, the clamps is larger relative to the other components than depicted in the figures. In other examples, the clamps is smaller relative to the other components than depicted in the figures. Further, the reader should understand that the clamps and the other components may all be larger or smaller than described herein while maintaining their relative proportions.

Plates

In cooperation with rail 104 and coupler 110, plate 108 serves to apply compressive force against vertical member 103 of ladder 102 to secure rail 104 to ladder 102. Similarly, second plate 120 in cooperation with arm 118 and second coupler 121 serves to apply compressive force against vertical member 103 of ladder 102 to secure arm 118 to ladder 102.

With reference to FIG. 6, plate 108 is disposed on a second side 109 of vertical member 103. Second side 109 is opposite first side 105 of vertical member 103. As shown in FIG. 6, plate 108 defines plate slot 111 extending through plate 108. As shown in FIG. 6, coupler 110 extends through plate slot 111 and through mounting slot 112 of rail 104 to compressively couple plate 108 with rail 104.

The reader can see in FIG. 7 that second plate 120 is disposed on second side 109 of vertical member 103. Second plate 120 defines a second plate slot (obscured by interface plate 130) extending through second plate 120. Second coupler 121 extends through the second plate slot and through arm mounting slot 123 of arm 118 to compressively couple second plate 120 with arm 118.

The size and shape of the plates may be varied as needed for a given application. In some examples, the plate is larger relative to the other components than depicted in the figures. In other examples, the plate is smaller relative to the other components than depicted in the figures. Further, the reader should understand that the plate and the other components may all be larger or smaller than described herein while maintaining their relative proportions.

In the present example, the plates are composed of metal. However, the plates may be composed of any currently known or later developed material suitable for backplate applications. Suitable materials include metals, polymers, ceramics, wood, and composite materials.

Plate Slots

The number of plate slots in the rack may be selected to meet the needs of a given application. The reader should appreciate that the number of plate slots may be different in other examples than is shown in the figures. For instance, some rack examples include additional or fewer plate slots than described in the present example.

The size and shape of the plate slots may be varied as needed for a given application. In some examples, the plate slots are larger relative to the other components than depicted in the figures. In other examples, the plate slots are smaller relative to the other components than depicted in the figures. Further, the reader should understand that the plate slots and the other components may all be larger or smaller than described herein while maintaining their relative proportions.

Couplers

With reference to FIG. 6, coupler 110 is configured to compress vertical member 103 between plate 108 and rail 104. As shown in FIG. 6, coupler 110 compressively couples plate 108 and rail 104 together. The reader can see in FIG. 6 that coupler 110 extends through plate slot 111 and through mounting slot 112 to compressively couple plate 108 with rail 104. As shown in FIG. 6, coupler 110 extends past front face 113.

As shown in FIG. 6, couplers 150 secure hook 107 to rail 104. Couplers 150 are configured similarly to coupler 110, but shorter in length.

With reference to FIG. 7, second coupler 121 compressively couples second plate 120 and arm 118. As shown in FIG. 7, second coupler 121 is configured to compress vertical member 103 between second plate 120 and arm 118. The reader can see in FIG. 7 that second coupler 121 extends through arm mounting slot 123 to extend past arm front face 124.

As depicted in FIG. 6, coupler 110 includes a bolt 114 and a nut 115. As depicted in FIG. 7, second coupler 121 includes a second bolt 125 and a second nut 126. The bolt and the nut components are described in more detail in the sections below.

The number of couplers in the rack may be selected to meet the needs of a given application. The reader should appreciate that the number of couplers may be different in other examples than is shown in the figures. For instance, some rack examples include additional or fewer couplers than described in the present example.

The coupler may be any currently known or later developed type of coupler. A variety of coupler types exist and could be used in place of the coupler shown in the figures. In addition to the types of couplers existing currently, it is contemplated that the racks described herein could incorporate new types of couplers developed in the future.

The bolts serve to compressively link the plates of the clamps with the rail and the arm on opposite sides of ladder 102. With reference to FIG. 6, bolt 114 extends through plate slot 111 and through mounting slot 112 to extend past front face 113. Second bolt 125 extends through the second plate slot and through arm mounting slot 123 to extend past arm front face 124.

The bolts may be any currently known or later developed type of bolt. Various bolt types exist and could be used in place of the bolts shown in the figures. In addition to the types of bolts existing currently, it is contemplated that the racks described herein could incorporate new types of bolts developed in the future.

The size and shape of the bolts may be varied as needed for a given application. In some examples, the bolts are larger relative to the other components than depicted in the figures. In other examples, the bolts are smaller relative to the other components than depicted in the figures. Further, the reader should understand that the bolts and the other components may all be larger or smaller than described herein while maintaining their relative proportions.

The number of bolts in the rack may be selected to meet the needs of a given application. The reader should appreciate that the number of bolts may be different in other examples than is shown in the figures. For instance, some rack examples include additional or fewer bolts than described in the present example.

The nuts serve to exert compressive force on the bolts and on rail 104 and the arm 118 to couple rail 104 and arm 118 to ladder 102. The reader can see in FIG. 6 that nut 115 is threadingly mounted to bolt 114 proximate front face 113. Nut 115 is configured to press front face 113 of rail 104 towards plate 108. Nut 115 pressing front face 113 towards plate 108 compresses vertical member 103 between plate 108 and rail 104.

As depicted in FIG. 7, second nut 126 is threadingly mounted to second bolt 125 proximate arm front face 124. Second nut 126 is configured to press arm front face 124 towards second plate 120. Second nut 126 pressing arm front face 124 towards second plate 120 compresses vertical member 103 between second plate 120 and arm 118.

The nuts may be any currently known or later developed type of nut. Various nut types exist and could be used in place of the nuts shown in the figures. In addition to the types of nuts existing currently, it is contemplated that the racks described herein could incorporate new types of nuts developed in the future.

The number of nuts in the rack may be selected to meet the needs of a given application. The reader should appreciate that the number of nuts may be different in other examples than is shown in the figures. For instance, some rack examples include additional or fewer nuts than described in the present example.

The size and shape of the nut may be varied as needed for a given application. In some examples, the nut is larger relative to the other components than depicted in the figures. In other examples, the nut is smaller relative to the other components than depicted in the figures. Further, the reader should understand that the nut and the other components may all be larger or smaller than described herein while maintaining their relative proportions.

Arm

Arm 118 functions to support items from a position vertically spaced from rail 104. For example, as shown in FIGS. 1-4, arm 118 supports a rear tire of a bicycle hanging from hook 107 on rail 104.

With reference to FIGS. 1-3, 5, and 7, arm 118 abuts a first side 105 of vertical member 103 of ladder 102. As shown in FIGS. 1-3, 5, and 7, arm 118 is vertically spaced from rail 104. In the present example, arm 118 is disposed at a lower vertical position than rail 104.

With reference to FIGS. 1, 3, 5, and 7, arm 118 includes an interface plate 130, a support plate 127, and a second retention strap 129. Interface plate 130, support plate 127, and second retention strap 129 are explained in more detail in the sections below.

The number of arms in the rack may be selected to meet the needs of a given application. The reader should appreciate that the number of arms may be different in other examples than is shown in the figures. For instance, some rack examples include additional or fewer arms than described in the present example.

The size and shape of the arm may be varied as needed for a given application. In some examples, the arm is larger relative to the other components than depicted in the figures. In other examples, the arm is smaller relative to the other components than depicted in the figures. Further, the reader should understand that the arm and the other components may all be larger or smaller than described herein while maintaining their relative proportions.

In the present example, the arm is composed of metal. However, the arm may be composed of any currently known or later developed material suitable for structural applications. Suitable materials include metals, polymers, ceramics, wood, and composite materials.

Interface Plate

The role of interface plate 130 is to cooperate with second clamp 119 to compressively couple arm 118 to ladder 102. The reader can see in FIG. 7 that interface plate 130 abuts vertical member 103 and defines arm front face 124 facing away from vertical member 103. As depicted in FIG. 7, interface plate 130 is integrally coupled to support plate 127.

As shown in FIG. 7, interface plate 130 defines arm mounting slot 123 extending through interface plate 130. As depicted in FIG. 7, arm mounting slot 123 extends longitudinally. Arm mounting slot 123 extending longitudinally enables second coupler 121 to extend through arm mounting slot 123 in a selected longitudinal position along arm 118.

In the present example, the interface plate is composed of metal. However, the interface plate may be composed of any currently known or later developed material suitable for structural applications. Suitable materials include metals, polymers, ceramics, wood, and composite materials.

The size and shape of the interface plate may be varied as needed for a given application. In some examples, the interface plate is larger relative to the other components than depicted in the figures. In other examples, the interface plate is smaller relative to the other components than depicted in the figures. Further, the reader should understand that the interface plate and the other components may all be larger or smaller than described herein while maintaining their relative proportions.

Support Plate

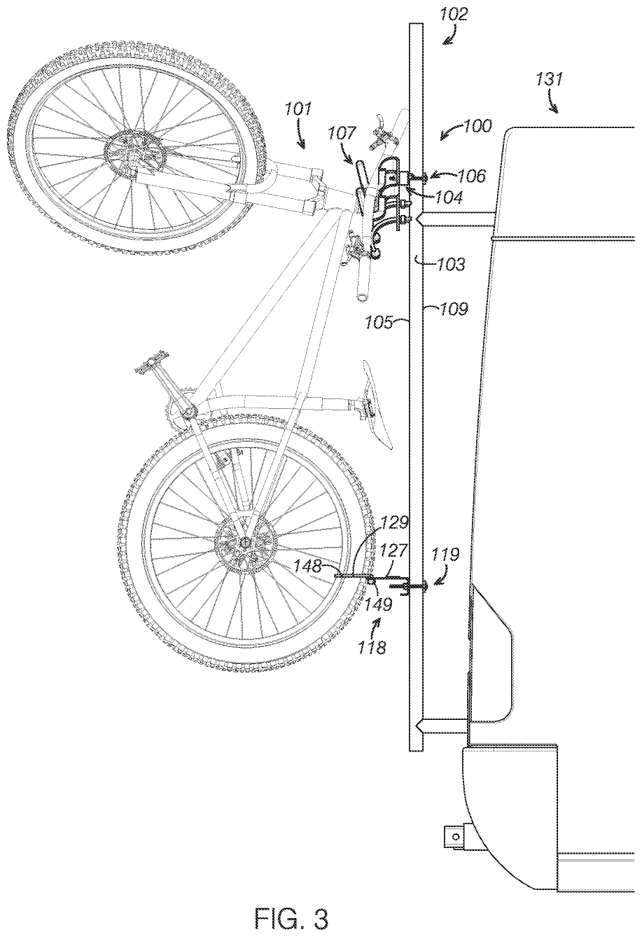

As shown in FIGS. 1 and 3, support plate 127 is operable to restrict item 101 from contacting vertical member 103 proximate arm 118 when item 101 is supported by hook 107. As shown in FIGS. 1, 3, 5, and 7, support plate 127 extends transverse to support plate 127 and away from vertical member 103. As depicted in FIG. 7, interface plate 130 is integrally coupled to support plate 127.

The reader can see in FIGS. 1, 3, 5, and 7 that support plate 127 defines a recess 128 and a retention slot 151. Retention slot 151 is configured to selectively retain second retention member 129.

Recess 128 is configured to receive a portion of item 101. In the example shown in FIGS. 1-4, recess 128 receives a portion of a rear wheel of the bicycle hanging from hook 107. Recess 128 is configured to restrict item 101 from moving by abutting the portion of item 101 within recess 128 on multiple sides.

The size and shape of the support plate may be varied as needed for a given application. In some examples, the support plate is larger relative to the other components than depicted in the figures. In other examples, the support plate is smaller relative to the other components than depicted in the figures. Further, the reader should understand that the support plate and the other components may all be larger or smaller than described herein while maintaining their relative proportions.

Arm Mounting Slot

The size and shape of the arm mounting slot may be varied as needed for a given application. In some examples, the arm mounting slot is larger relative to the other components than depicted in the figures. In other examples, the arm mounting slot is smaller relative to the other components than depicted in the figures. Further, the reader should understand that the arm mounting slot and the other components may all be larger or smaller than described herein while maintaining their relative proportions.

The number of arm mounting slots in the rack may be selected to meet the needs of a given application. The reader should appreciate that the number of arm mounting slots may be different in other examples than is shown in the figures. For instance, some rack examples include additional or fewer arm mounting slots than described in the present example.

Retention Strap

With reference to FIG. 3, second retention strap 129 is operable to selectively restrict the portion of item 101 within recess 128 from exiting recess 128. For example, second retention strap 129 may be wrapped over the bicycle wheel received in recess 128 and secured in retention slot 151 of arm 118 to secure the bicycle wheel in recess 128. As shown in FIG. 7, second retention strap 129 is disposed proximate recess 128.

As depicted in FIG. 7, second retention strap 129 includes an elongate tension bearing member 148 and a boss 149. Elongate tension bearing member 148 may be passed through the wheel of a bike and into retention slot 151. Boss 149 restricts elongate tension bearing member 148 from exiting retention slot 151.

The retention straps may be any currently known or later developed type of retention straps. A variety of retention straps types exist and could be used in place of the retention straps shown in the figures. In addition to the types of retention straps existing currently, it is contemplated that the racks described herein could incorporate new types of retention straps developed in the future.

The number of retention straps in the rack may be selected to meet the needs of a given application. The reader should appreciate that the number of retention straps may be different in other examples than is shown in the figures. For instance, some rack examples include additional or fewer retention straps than described in the present example.

The size and shape of the retention straps may be varied as needed for a given application. In some examples, the retention straps is larger relative to the other components than depicted in the figures. In other examples, the retention straps is smaller relative to the other components than depicted in the figures. Further, the reader should understand that the retention straps and the other components may all be larger or smaller than described herein while maintaining their relative proportions.

Hook

Hook 107 is configured to support item 101. As shown in FIGS. 1-6, hook 107 mounts to rail 104 via couplers 150. With reference to FIGS. 1-6, hook 107 mounts to couplers 150 proximate front face 113 of rail 104.

The reader can see in FIGS. 1-6 that hook 107 is oriented at an angle relative to rail 104 to support item 101 in a horizontally tilted orientation. The horizontally tilted orientation of hook 107 allows tighter lateral packing of adjacent bikes by supporting the handlebars of the bike in a tilted orientation that reduces the lateral space required for the handlebars. Hook 107 being tilted enables bikes to be mounted to rack 100 in a smaller footprint than conventional bike racks designed to store multiple bikes.

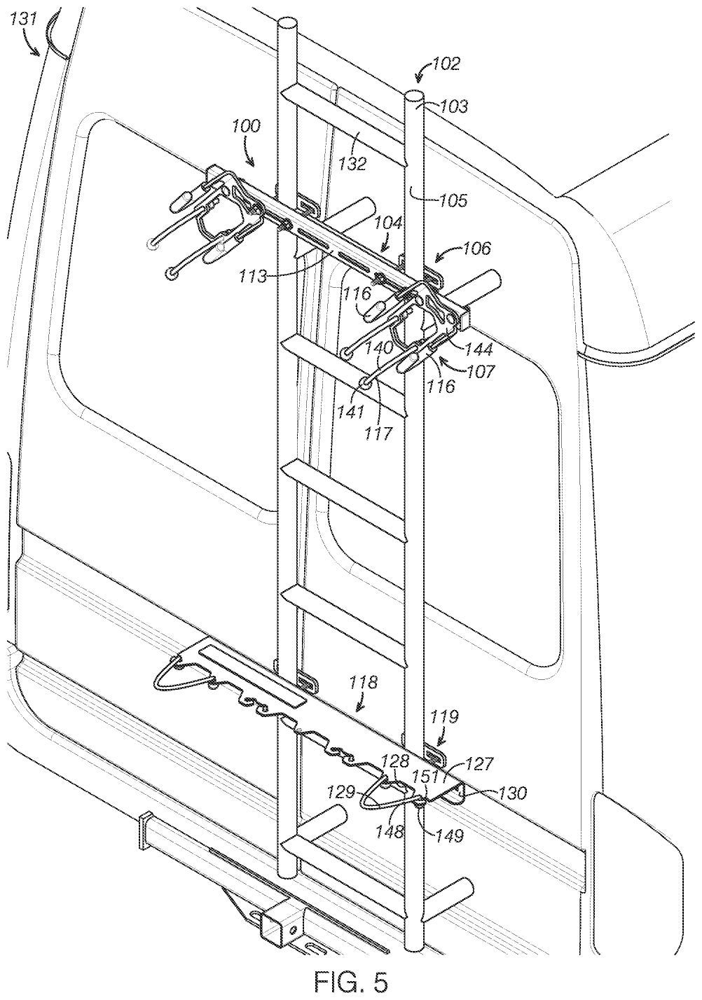

As depicted in FIGS. 5 and 6, hook 107 includes a hook body 144, hook members 116, and a retention member 117. Hook body 144, hook members 116, and retention member 117 are described in more detail in the sections below.

The number of hooks in the rack may be selected to meet the needs of a given application. The reader should appreciate that the number of hooks may be different in other examples than is shown in the figures. For instance, some rack examples include additional or fewer hooks than described in the present example.

The hook may be any currently known or later developed type of hook. Various hook types exist and could be used in place of the hook shown in the figures. In addition to the types of hooks existing currently, it is contemplated that the racks described herein could incorporate new types of hooks developed in the future.

The size and shape of the hook may be varied as needed for a given application. In some examples, the hook is larger relative to the other components than depicted in the figures. In other examples, the hook is smaller relative to the other components than depicted in the figures. Further, the reader should understand that the hook and the other components may all be larger or smaller than described herein while maintaining their relative proportions.

Hook Members

Hook members 116 are configured to support item 101. In the present example, hook members 116 support the handlebars of a bicycle.

With reference to FIGS. 1-4, hook members 116 are laterally spaced from each other and are mounted to hook body 144. The reader can see in FIGS. 1-4 and 6 that hook members 116 are tilted at an angle relative to horizontal. The tilted angle facilitates denser packing of items 101 on rack 100.

The size and shape of the hook members may be varied as needed for a given application. In some examples, the hook members are larger relative to the other components than depicted in the figures. In other examples, the hook members are smaller relative to the other components than depicted in the figures. The hook members and the other components may all be larger or smaller than described herein while maintaining their relative proportions.

The number of hook members in the rack may be selected to meet the needs of a given application. The reader should appreciate that the number of hook members may be different in other examples than is shown in the figures. For instance, some rack examples include additional or fewer hook members than described in the present example.

The hook members may be any currently known or later developed type of hook. Various hook types exist and could be used in place of the hook members shown in the figures. In addition to the types of hooks existing currently, it is contemplated that the racks described herein could incorporate new types of hook members developed in the future.

Retention Member

Retention member 117 is operable to selectively secure item 101 supported on hook members 116. For example, retention member 117 may be wrapped around the handlebars of the bike supported on hook 107 as depicted in FIGS. 1-4. Securing the retention member 117 to hook 107 after wrapping the retention member around the handlebars functions to secure the handlebars on hook members 116.

As shown in FIGS. 1-6, retention member 117 is proximate to hook member 116. Retention member 117 includes an elongate tension bearing member 140 and a boss 141. Boss 141 is coupled to an end of elongate tension bearing member 140.

Hook body 144 defines a slot 142 into which elongate tension bearing member 140 may be inserted to selectively couple retention member 117 to hook body 144. Boss 141 and slot 142 are complementarily configured to restrict boss 141 passing through slot 142.

The size and shape of the retention member may be varied as needed for a given application. In some examples, the retention member is larger relative to the other components than depicted in the figures. In other examples, the retention member is smaller relative to the other components than depicted in the figures. Further, the reader should understand that the retention member and the other components may all be larger or smaller than described herein while maintaining their relative proportions.

The number of retention members in the rack may be selected to meet the needs of a given application. The reader should appreciate that the number of retention members may be different in other examples than is shown in the figures. For instance, some rack examples include additional or fewer retention members than described in the present example.

The retention member may be any currently known or later developed type of retention member. Various retention member types exist and could be used in place of the retention member shown in the figures. In addition to the types of retention members existing currently, it is contemplated that the racks described herein could incorporate new types of retention members developed in the future.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and noni-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A rack for supporting an item and mounting to a ladder having a vertical member, comprising:
a rail abutting a first side of the vertical member of the ladder;
a clamp securing the rail to the vertical member of the ladder; and
a hook operatively mounted to the rail and configured to support the item;
wherein the clamp includes:
a plate disposed on a second side of the vertical member, the second side is opposite the first side; and
a coupler coupling the plate and the rail;
wherein the coupler is configured to compress the vertical member between the plate and the rail.

2. The rack of claim 1, wherein:
the plate defines a plate slot extending through the plate;
the rail defines a mounting slot extending through the rail;
the rail defines a front face facing away from the vertical member; and
the coupler extends through the mounting slot to extend past the front face.

3. The rack of claim 2, wherein the coupler includes:
a bolt extending through the plate slot and through the mounting slot to extend past the front face; and
a nut threadingly mounted to the bolt proximate the front face and configured to press the front face of the rail towards the plate to compress the vertical member between the plate and the rail.

4. The rack of claim 2, wherein the mounting slot extends longitudinally to enable the coupler to extend through the mounting slot in a selected longitudinal position along the rail.

5. The rack of claim 2, wherein the hook mounts to the coupler proximate the front face of the rail.

6. The rack of claim 5, wherein the hook further mounts to the rail.

7. The rack of claim 6, wherein:
the rail extends horizontally; and
the hook is oriented at an angle relative to the rail to support the object in a horizontally tilted orientation.

8. The rack of claim 1, wherein the hook includes:
a hook member configured to support the item; and
a retention member proximate to the hook member and operable to selectively secure the item supported on the hook member.

9. The rack of claim 1, further comprising:
an arm abutting a first side of the vertical member of the ladder and vertically spaced from the rail; and
a second clamp securing the arm to the vertical member of the ladder.

10. The rack of claim 9, wherein the second clamp includes:
a second plate disposed on the second side of the vertical member; and
a second coupler coupling the second plate and the arm rail.

11. The rack of claim 10, wherein the second coupler is configured to compress the vertical member between the second plate and the arm.

12. The rack of claim 11, wherein:
the second plate defines a second plate slot extending through the second plate;
the arm defines an arm mounting slot extending through the arm;
the arm defines an arm front face facing away from the vertical member; and
the second coupler extends through the arm mounting slot to extend past the arm front face.

13. The rack of claim 12, wherein the second coupler includes:
a second bolt extending through the second plate slot and through the arm mounting slot to extend past the arm front face; and
a second nut threadingly mounted to the second bolt proximate the arm front face and configured to press the arm front face towards the second plate to compress the vertical member between the second plate and the arm.

14. The rack of claim 12, wherein the arm mounting slot extends longitudinally to enable the second coupler to extend through the arm mounting slot in a selected longitudinal position along the arm.

15. The rack of claim 9, wherein the arm includes a support plate extending away from the vertical member.

16. The rack of claim 15, wherein the support plate is operable to restrict the item from contacting the vertical member proximate the arm when the item is supported by the hook.

17. The rack of claim 16, wherein the support plate defines a recess to receive a portion of the item and to restrict the item from moving by abutting the portion of the item within the recess on multiple sides.

18. The rack of claim 17, wherein:
the arm includes a second retention strap proximate the recess; and
the second retention strap is operable to selectively restrict the portion of the item within the recess from exiting the recess.

19. The rack of claim 15, wherein the arm includes an interface plate extending transverse to the support plate and abutting the vertical member.

20. The rack of claim 18, wherein the interface plate is integrally coupled to the support plate.
